(19) United States
(12) Patent Application Publication
(10) Pub. No.: US 2013/0111154 A1
(43) Pub. Date: May 2, 2013

(54) CONTROL DEVICE OF VIRTUAL STORAGE SYSTEM, VIRTUAL STORAGE SYSTEM, AND METHOD FOR CONTROLLING VIRTUAL STORAGE SYSTEM

(71) Applicant: Fujitsu Limited, Kawasaki-shi (JP)

(72) Inventor: Yukio TANIYAMA, Yokohama (JP)

(73) Assignee: Fujitsu Limited, Kawasaki-shi (JP)

(21) Appl. No.: 13/625,346

(22) Filed: Sep. 24, 2012

(30) Foreign Application Priority Data
Oct. 27, 2011 (JP) 2011-236538

(51) Int. Cl. G06F 12/00

(52) U.S. Cl. 711/154; 711/E12.001

(57) ABSTRACT

A control device of a virtual storage system includes a physical drive to store data of a logical volume in a storage medium and a plurality of processing devices to perform a mount process or an un-mount process for mounting the logical volume on a virtual drive that virtually stores data of the logical volume or for mounting a physical volume on the physical drive. The control device acquires operation information indicating operation states of the plurality of processing devices and load information of the mount process from the processing devices, determines a processing device to be started or to be stopped from the plurality of processing devices based on the acquired load information of the mount process, and starts or stops the determined the processing device.

### CROSS-REFERENCE TO RELATED APPLICATION

This application is based upon and claims the benefit of priority of the prior Japanese Patent Application No. 2011-236538, filed on Oct. 27, 2011, the entire contents of which are incorporated herein by reference.

### FIELD

The embodiment discussed herein is related to a control device of a virtual storage system, a virtual storage system, and a method for controlling a virtual system.

### BACKGROUND

An actual tape library device includes a plurality of tape drive devices and a plurality of tape cartridge transfer robot devices. In a high performance mode, many physical tape drive devices and robot devices are used. On the other hand, in a low performance mode, only part of the physical drive devices is used and the power of the unused tape drive devices are manually turned off to perform a power saving operation. When a hardware failure occurs, a failed unit (tape drive device) is separated from the configuration of the tape library device, and a failed part is replaced after the power is turned off.

A virtual tape library device has a group of a plurality of hierarchically connected data processing units and virtually emulates (reconfigures) a plurality of tape drive devices and a plurality of tape cartridge transfer devices to provide the same function as that of the actual tape library device.

Therefore, in the virtual tape library device, it is difficult to separate an individual hardware data processing unit and turn on/off power in the same way as performed in a device using a conventional technique, so that a power saving operation may not be performed.

Japanese Laid-open Patent Publication No. 2010-86145 and Japanese Laid-open Patent Publication No. 9-138716 are examples of related art.

### SUMMARY

According to an aspect of the invention, a virtual storage system includes a physical drive to store data of a logical volume in a storage medium and a plurality of processing devices to perform a mount process or an un-mount process for mounting the logical volume on a virtual drive that virtually stores data of the logical volume or for mounting a physical volume on the physical drive, and a control device. The control device acquires operation information indicating operation states of the plurality of processing devices and load information of the mount process from the processing devices, determines a processing device to be started or to be stopped from the plurality of processing devices based on the acquired load information of the mount process, load prediction information of the mount process and the number of the operating processing devices obtained from the acquired operation information, and starts or stops the determined the processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a virtual tape device according to an embodiment.

FIG. 2 is an example of processing unit state information.

FIG. 3 is an example of a mount performance prediction table.

FIG. 4 is an example of a data transfer performance prediction table.

FIG. 5 is an example of a mount performance comparison table.

FIG. 6 is an example of a data transfer performance comparison table.

FIG. 7 is a configuration diagram in high performance mode of the virtual tape device according to the embodiment.

FIG. 8 is a configuration diagram in intermediate performance mode of the virtual tape device according to the embodiment.

FIG. 9 is a configuration diagram in low performance mode of the virtual tape device according to the embodiment.

FIG. 10 is a configuration diagram in physical tape drive rest mode of the virtual tape device according to the embodiment.

FIGS. 11A, 11B, and 11C are methods of a configuration change process according to the embodiment.

FIG. 12 is a detailed method of a high-to-low configuration change process.

FIG. 13 is a detailed method of an intermediate-to-low configuration change process.

FIG. 14 is a detailed method of a high-to-intermediate configuration change process.

FIG. 15 is a detailed method of a low-to-intermediate configuration change process.

FIG. 16 is a detailed method of an intermediate-to-high configuration change process.

FIG. 17 is a detailed method of a low-to-high configuration change process.

FIG. 18 is a configuration diagram of an information processing device (a computer).

### DESCRIPTION OF EMBODIMENT

Hereinafter, an embodiment will be described with reference to the drawings.

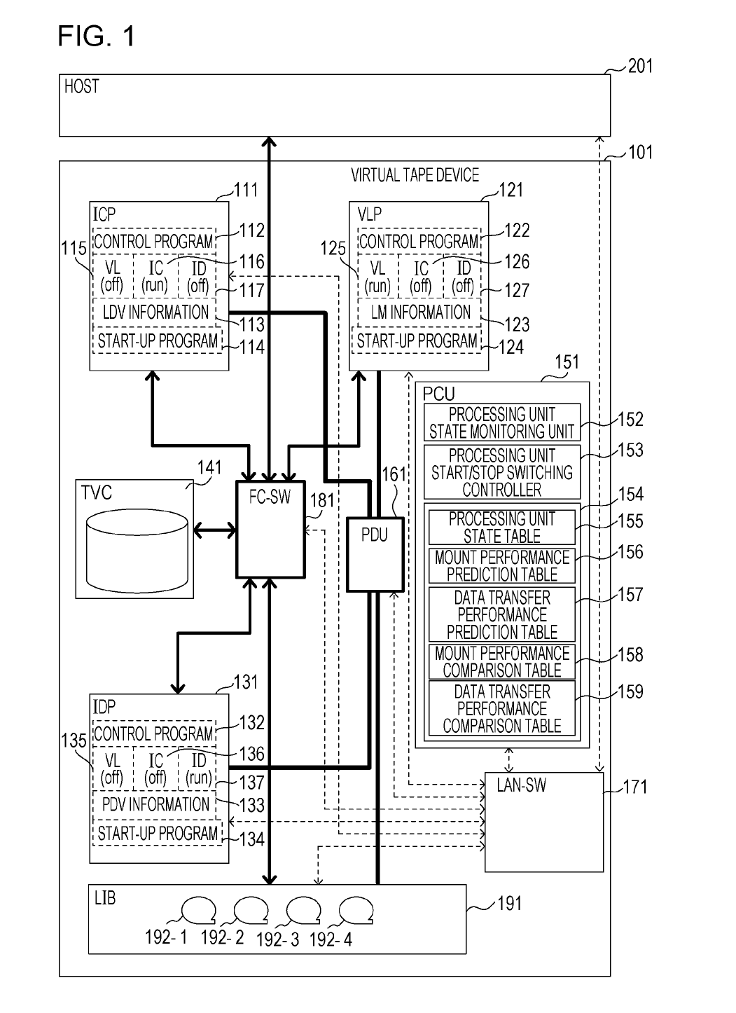

FIG. 1 is a configuration diagram of a virtual tape device according to the embodiment.

A virtual tape device 101 is an example of a virtual storage system and emulates a plurality of virtual tape devices.

A virtual tape device 101 is connected to a host 201 through a Fibre Channel.

The host 201 is a host computer which controls writing data to the virtual tape device 101 and reading data from the virtual tape device 101.

The virtual tape device 101 includes an Integrated Channel Processor (ICP) 111, a Virtual Library Processor (VLP) 121, an Integrated Device Processor (IDP) 131, a Tape Volume Cache (TVC) 141, a Power Control Unit (PCU) 151, a Power Distribution Unit (PDU) 161, a LAN-SW 171, an FC-SW 181, and a Tape Library (LIB) 191.

The ICP 111 is a processing unit which is connected to the host 201 through the FC-SW 181 and controls transmitting and receiving data of a logical volume of the TVC 141. The function of the virtual tape drive is realized by the ICP 111.

The ICP 111 includes a control program 112, Logical Drive (LDV) information 113, and a start-up program 114.

The control program 112, the Logical Drive (LDV) information 113, and the start-up program 114 are stored in a storage unit (not illustrated in FIG. 1) included in the ICP 111.

A CPU (not illustrated in FIG. 1) included in the ICP 111 realizes various functions by reading the control program 112 and the start-up program 114 from the storage unit and executing them.

The control program 112 includes a VL function process (VL) 115, an IC function process (IC) 116, and an ID function process (ID) 117.

The VL 115 receives a mount request from the host 201 through the LAN-SW 171, mounts a logical volume on a virtual tape drive, and performs a mount process and an un-mount process of a physical volume of a physical tape drive 192.

The IC 116 controls transmission and reception of data of a logical volume in the TVC 141.

The ID 117 writes data of a logical volume of the TVC 141 to a physical drive of the LIB 191. The ID 117 reads data of a logical volume from the physical tape drive 192 of the LIB 191 and stores the data in the TVC 141.

In the configuration diagram of FIG. 1, the IC 116 is running (RUN) and the VL 115 and the ID 117 are disabled (OFF).

The IC 116 is running, so that the ICP 111 performs a process for controlling transmission and reception of data of a logical volume in the TVC 141.

When the control program 112 runs the VL 115, the ICP 111 can realize the same function as that of the VLP 121. When the control program 112 runs the ID 117, the ICP 111 can realize the same function as that of the IDP 131.

The LCV information 113 is operation information used by the IC 116 and includes logical block position information indicating which logical volume is mounted on which virtual drive and to which block writing or reading is completed.

The start-up program 114 causes each function process (VL 115, IC 116, and ID 117) to start, turn off (OFF), or stand by (STOP) according to an instruction of the PCU 151.

The VLP 121 receives a mount request from the host 201 through the LAN-SW 171, mounts a logical volume on a virtual tape drive, and performs a mount process and an un-mount process of a physical volume to a physical tape drive. The mount/un-mount process of a physical volume is performed by the LIB 191 and an optical Fibre Channel interface through the FC-SW 181.

The VLP 121 includes a control program 122, Library Management (LM) information 123, and a start-up program 124.

The control program 122, the Library Manage (LM) information 123, and the start-up program 124 are stored in a storage unit (not illustrated in FIG. 1) included in the VLP 121.

A CPU (not illustrated in FIG. 1) included in the VLP 121 realizes various functions by reading the control program 122 and the start-up program 124 from the storage unit and executing them.

The control program 122 includes a VL function process (VL) 125, an IC function process (IC) 126, and an ID function process (ID) 127.

The VL 125 receives a mount request from the host 201 through the LAN-SW 171, mounts a logical volume on a virtual tape drive, and performs a mount process and an un-mount process of a physical volume of the physical tape drive.

The IC 126 controls transmission/reception of data of a logical volume in the TVC 141.

The ID 127 writes data of a logical volume of the TVC 141 to a physical drive of the LIB 191. The ID 127 reads data of a logical volume from the physical tape drive 192 of the LIB 191 and stores the data in the TVC 141.

In the configuration diagram of FIG. 1, the VL 125 is running (RUN) and the IC 126 and the ID 127 are disabled (OFF).

The VL 125 is running, so that the VLP 121 mounts a logical volume on a virtual tape drive and performs a physical volume mount/un-mount process of the physical tape drive.

When the control program 122 runs the IC 126, the VLP 121 can realize the same function as that of the ICP 111. When the control program 122 runs the ID 127, the VLP 121 can realize the same function as that of the IDP 131.

The LM information 123 is operation information used by the VL 125 and includes information indicating which logical volume is mounted on which number of virtual tape drive and which physical volume is mounted on which number of physical tape drive 192.

The start-up program 124 causes each function process (VL 125, IC 126, and ID 127) to start, turn off, or stand by according to an instruction of the PCU 151.

The IDP 131 is a processing unit which receives an instruction from the VLP 121, writes data of a logical volume of the TVC 141 to a physical drive 192 of the LIB 191, reads data of a logical volume from the physical tape drive 192, and stores the data in the TVC 141.

The IDP 131 includes a control program 132, Physical Drive (PDV) information 133, and a start-up program 134.

The control program 132, the Physical Drive (PDV) information 133, and the start-up program 134 are stored in a storage unit (not illustrated in FIG. 1) included in the IDP 131.

A CPU (not illustrated in FIG. 1) included in the IDP 131 realizes various functions by reading the control program 132 and the start-up program 134 from the storage unit and executing them.

The control program 132 includes a VL function process (VL) 135, an IC function process (IC) 136, and an ID function process (ID) 137.

The VL 135 receives a mount request from the host 201 through the LAN-SW 171, mounts a logical volume on a virtual tape drive, and performs a mount process and an unmount process of a physical volume of the physical tape drive.

The IC 136 controls transmission/reception of data of a logical volume in the TVC 141.

The ID 137 writes data of a logical volume of the TVC 141 to a physical drive of the LIB 191. The ID 137 reads data of a logical volume from the physical tape drive 192 of the LIB 191 and stores the data in the TVC 141.

In the configuration diagram of FIG. 1, the ID 137 is running (RUN) and the VL 135 and the IC 136 are disabled (OFF).

The ID 137 is running, so that the IDP 131 writes data of a logical volume of the TVC 141 to a physical drive 192 of the LIB 191 and performs a process for reading data of a logical volume from the physical tape drive 192 and storing the data in the TVC 141.

When the control program 132 runs the VL 135, the IDP 131 can realize the same function as that of the VLP 121. When the control program 132 runs the IC 136, the IDP 131 can realize the same function as that of the ICP 111.

The PDV information 133 is operation information used by the ID 137 and includes physical block position information indicating which physical volume is mounted on which physical tape drive and to which block writing or reading is completed.

The start-up program 134 causes each function process (VL 135, IC 136, and ID 137) to start, turn off, or stand by according to an instruction of the PCU 151.

The TVC 141 is a data cache including a RAID and logical volume data is placed in the TVC 141.

The PCU 151 controls power-on and power off of all the processing units (ICP 111, VLP 121, and IDP 131) and the LIB 191.

The PCU 151 includes a monitoring function of all the processing units, monitors an operation state of each processing unit at all times, instructs a processing unit to stop the operation when detecting a failure of the processing unit, and issues an instruction to replace the processing unit and change a connection configuration.

The PCU 151 includes a processing unit state monitoring unit 152, a processing unit start/stop switching controller 153, and a storage unit 154.

The processing unit state monitoring unit 152 monitors an operation state of each processing unit.

When detecting a failure, the processing unit start/stop switching controller 153 issues an instruction to a processing unit with the failure to stop the operation and issues a start instruction to a processing unit which replaces the stopped processing unit. Also, the processing unit start/stop switching controller 153 instructs a processing unit to stop or start according to a load of the virtual tape device 101.

The storage unit 154 is a storage device for storing various data. The storage unit 154 is, for example, a magnetic disk device, a semiconductor storage device, or the like.

Storage unit 154 stores a processing unit state table 155, a mount performance prediction table 156, a data transfer performance prediction table 157, a mount performance comparison table 158, and a data transfer performance comparison table 159.

Details of the processing unit state table 155, the mount performance prediction table 156, the data transfer performance prediction table 157, the mount performance comparison table 158, and the data transfer performance comparison table 159 will be described later.

The PDU 161 receives an instruction from the PCU 151 through a LAN interface and supplies or stops power to each of the processing unit (ICP 111, VLP 121, and IDP 131) and the LIB 191.

The LAN-SW 171 is a relay unit which includes communication paths for referring to an operation state of each processing unit and instructing each processing unit to start operation and which distributes the communication to all the processing units.

The FC-SW 181 is a relay/switch unit of a data transfer path processed by the virtual tape device 101.

The LIB 191 is a physical tape library including a plurality of physical tape drives 192-i (i=1 to 4) and a physical volume carrier machine. Physical volume data is stored in the physical tape drive 192.

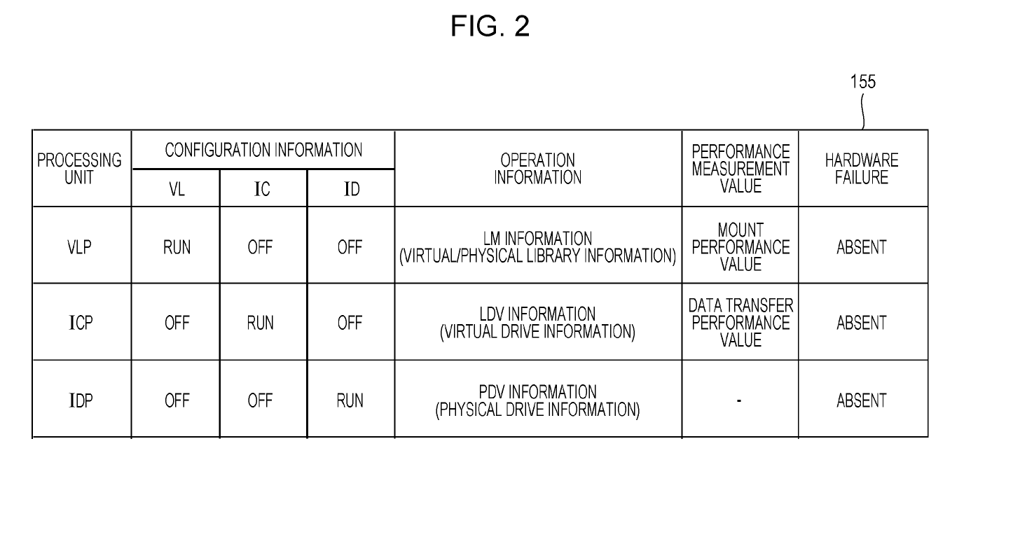

FIG. 2 is an example of processing unit state information.

Processing unit state information 155 has items of processing unit, configuration information, operation information, performance measurement value, and hardware failure.

The processing unit indicates the name of the processing unit.

The configuration information indicates a state of each function process (VL, IC, and ID) included in the processing unit. As the state, “RUN” indicating that the process is enabled and running, “STOP” indicating that the process is enabled and stopped, and “OFF” indicating that the process is disabled are described. In the processing unit state monitoring information 155 in FIG. 2, corresponding to the configuration in FIG. 1, VL is RUN and IC and ID are OFF in the VLP, IC is RUN and VL and ID are OFF in the ICP, and ID is RUN and VL and IC are OFF in the IDP.

The operation information indicates information held by the processing unit. The processing unit state monitoring information 155 in FIG. 2 illustrates that the VLP holds the LM information, the ICP holds the LDV information, and the IDP holds the PDV information.

The performance measurement value indicates information measured by the processing unit. The processing unit state monitoring information 155 in FIG. 2 illustrates that the VLP measures a mount performance value and the ICP measures a data transfer performance value. The mount performance value is the number of mount command processing times per unit time (per second in the embodiment). The data transfer performance value is data throughput per unit time (per second in the embodiment).

The hardware failure indicates whether or not the processing unit fails. A description of “present” indicates that the processing unit fails and a description of “absent” indicates that the processing unit does not fail.

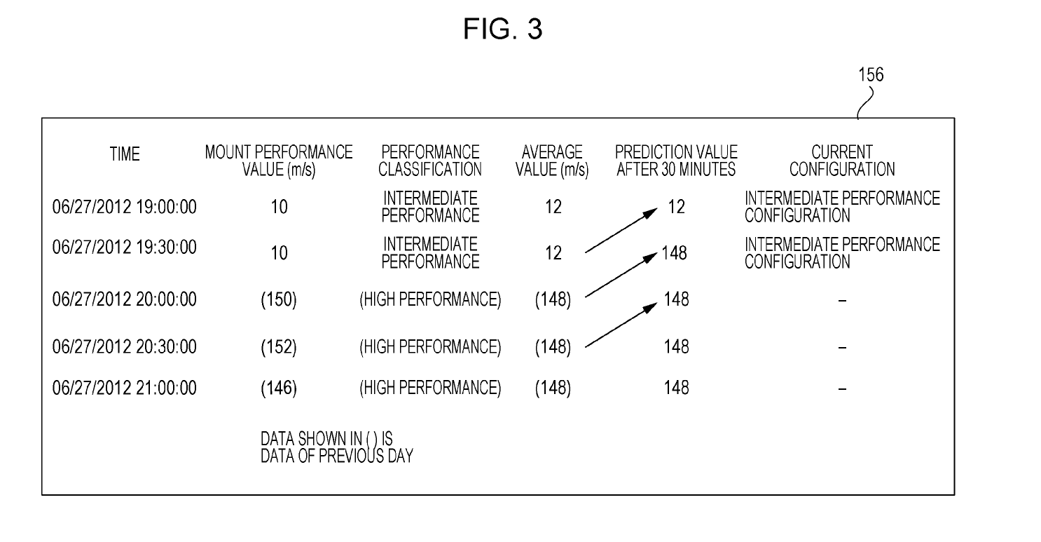

FIG. 3 is an example of the mount performance prediction table.

The mount performance prediction table 156 in FIG. 3 illustrates a table at 19:30:00 on Jun. 27, 2012.

The mount performance prediction table 156 has items of time, mount performance value (m/s), performance classification, average value (m/s), prediction value after 30 minutes, and current configuration.

The time indicates a time when the mount performance value is measured. For example, Jun. 27, 2012 19:00:00 in the first line of the mount performance prediction table 156 in FIG. 3 indicates 19:00:00 on Jun. 27, 2012. The time is described every 30 minutes.

The mount performance value (m/s) is the number of mount command processing times per unit time (per second in the embodiment). The unit of the mount performance value is mounts/second (m/s).

The performance classification indicates the magnitude of load when the mount performance value is classified by a predetermined condition. In the embodiment, when the mount performance value is greater than or equal to 100 m/s, it is defined as high performance (high load), when the mount performance value is greater than or equal to 1 m/s and smaller than 100 m/s, it is defined as intermediate performance (intermediate load), and when the mount performance value is smaller than 1 m/s, it is defined as low performance (low load).

The average value (m/s) is an average value of the mount performance values at the time in the past. Before calculating the average value, data of the previous day is described. For example, the average value in the third line of the mount performance prediction table 156, that is, the average value of the 20:00:00 on Jun. 27, 2012, has not been calculated, so that the average value of the previous day is described.

The prediction value after 30 minutes is a prediction value of the mount performance value after 30 minutes. In the embodiment, the prediction value after 30 minutes is the average value in the next line in the mount performance prediction table 156. For example, in the mount performance prediction table 156 in FIG. 3, the prediction value after 30 minutes in the second line (that is, the line of the time Jun. 27, 2012 19:30:00) is 148 because the average value in the third line (that is, the line of the time Jun. 27, 2012 20:00:00) is 148.

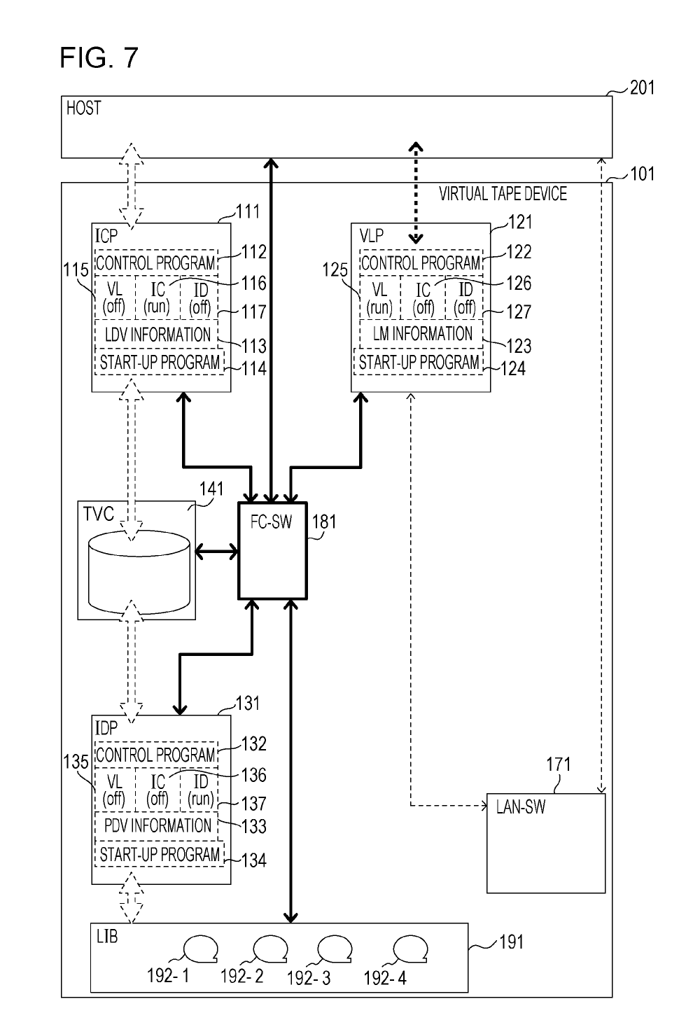

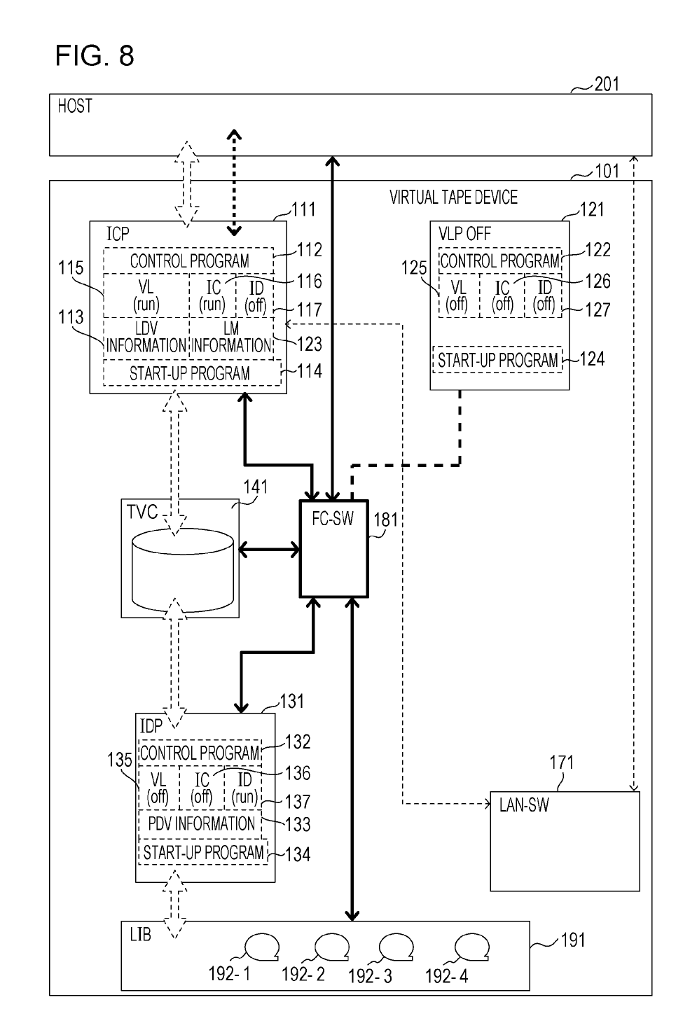

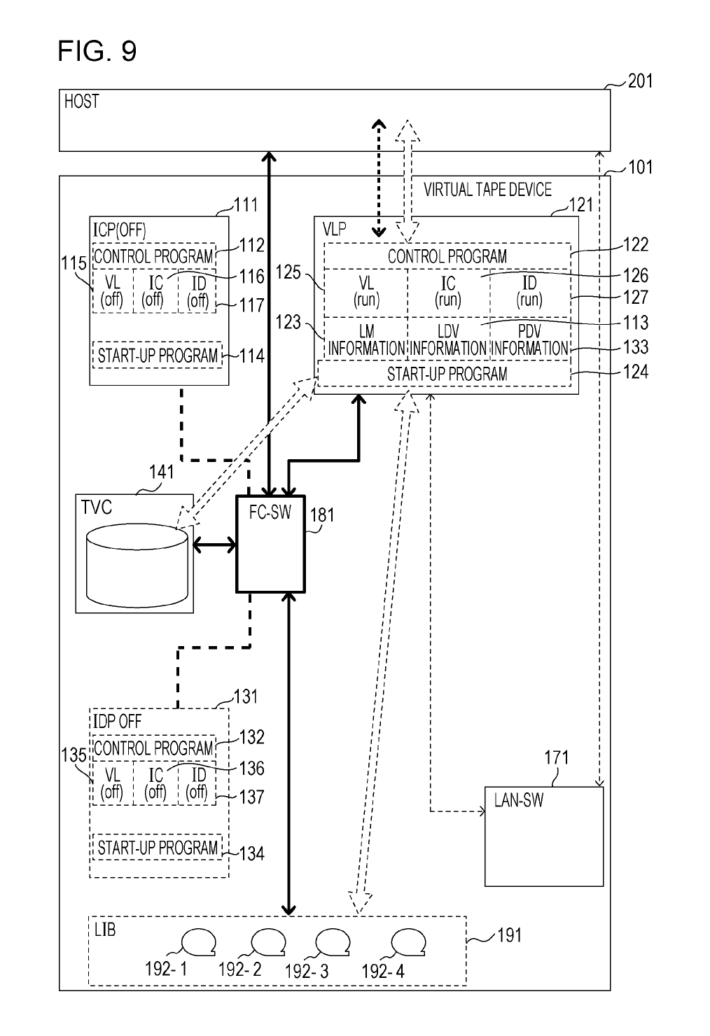

The current configuration indicates the current configuration of the virtual tape device 101, that is, the current performance of the virtual tape device 101. In other words, the current configuration indicates the number of processing units currently running in the virtual tape device 101. As the current configuration, high performance configuration, intermediate performance configuration, or low performance configuration is described. As illustrated in FIG. 7, when the ICP 111, the VLP 121, and the IDP 131 are running, the high performance configuration is described. As illustrated in FIG. 8, when the VLP 121 stops and the ICP 111 and the IDP 131 are running, the intermediate performance configuration is described. As illustrated in FIG. 9, when the ICP 111 and the IDP 131 stop and the VLP 121 is running, the low performance configuration is described.

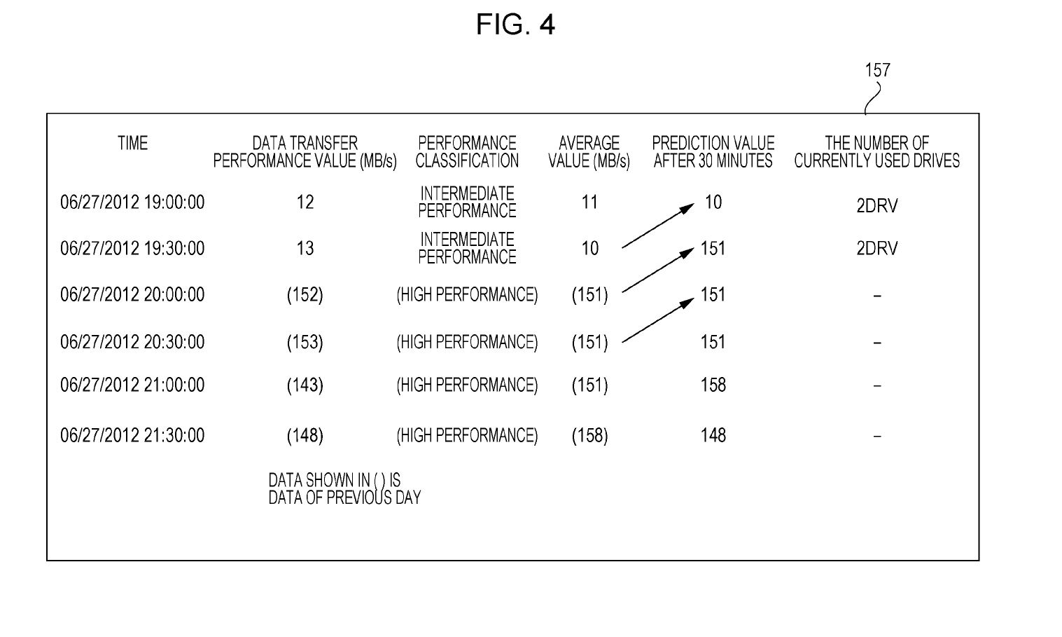

FIG. 4 is an example of the data transfer performance prediction table.

The data transfer performance prediction table 157 has items of time, data transfer performance value (MB/s), performance classification, average value (MB/s), prediction value after 30 minutes, and the number of currently used drives.

The time indicates a time when the data transfer performance value is measured. The time is described every 30 minutes.

The data transfer performance value (MB/s) is data throughput per unit time (per second in the embodiment). The unit of the data transfer performance value is MB/s.

The performance classification indicates the magnitude of load when the data transfer performance value is classified by a predetermined condition. In the embodiment, when the data transfer performance value is greater than or equal to 100 MB/s, it is defined as high performance (high load), when the data transfer performance value is greater than 0 MB/s and smaller than 100 MB/s, it is defined as intermediate performance (intermediate load), and when the mount performance value is 0 MB/s (that is, a state in which no data is transferred), it is defined as low performance (low load).

The average value (MB/s) is an average value of the data transfer performance values at the time in a predetermined number of days in the past. Before calculating the average value, data of the previous day is described. For example, the average value in the third line of the data transfer performance prediction table 157, that is, the average value of the 20:00:00 on Jun. 27, 2012, has not been calculated, so that the average value of the previous day is described.

The prediction value after 30 minutes is a prediction value of the data transfer performance value after 30 minutes. In the embodiment, the prediction value after 30 minutes is the average value in the next line in the data transfer performance prediction table 157. For example, in the data transfer performance prediction table 157 in FIG. 4, the prediction value after 30 minutes in the second line (that is, the line of the time Jun. 27, 2012 19:30:00) is 151 because the average value in the third line (that is, the line of the time Jun. 27, 2012 20:00:00) is 151.

The number of currently used drives indicates the number of the physical tape drives currently used by the LIB 191.

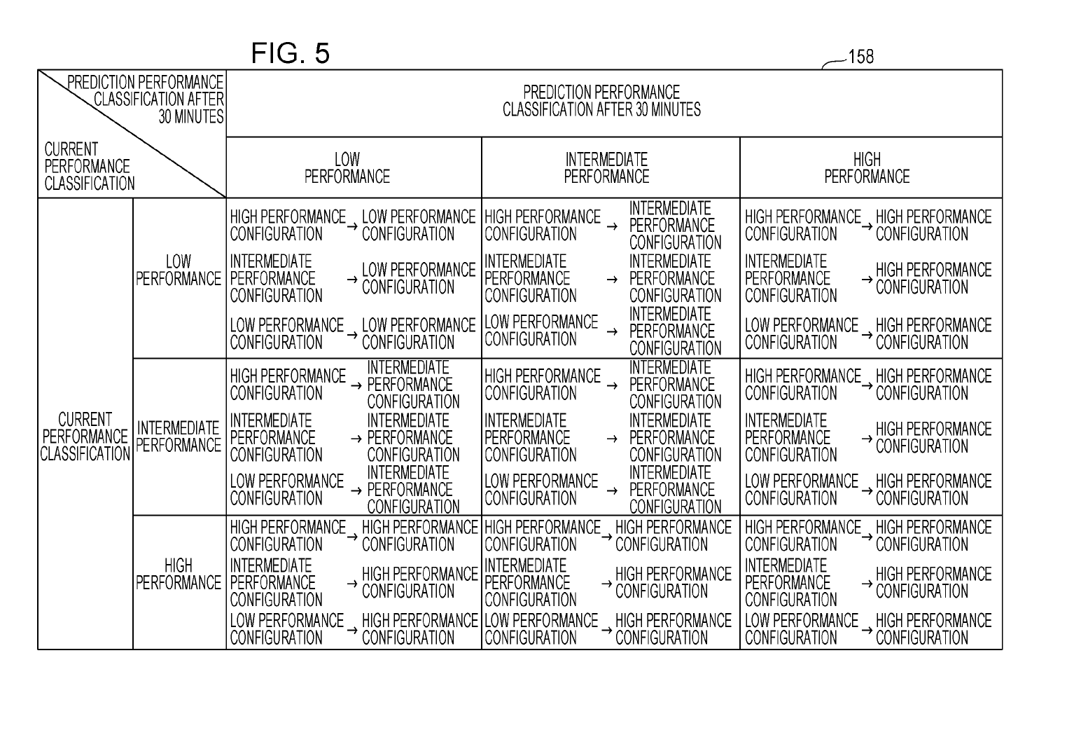

FIG. 5 is an example of the mount performance comparison table.

The mount performance comparison table 158 has a column item of prediction value after 30 minutes and a row item of current performance classification. Each of the prediction value after 30 minutes and the current performance classification has items of low performance, intermediate performance, and high performance.

In each field of the mount performance comparison table 158, a current configuration and a configuration after change are described. In each field of the mount performance comparison table 158, the current configuration is described on the left side of the right arrow (->) and the configuration after change is described on the right side of the right arrow.

For example, in a field corresponding to a row in which the current performance classification is low performance and a column in which the prediction performance classification after 30 minutes is low performance, high performance configuration->low performance configuration, intermediate performance configuration->low performance configuration, and low performance configuration->low performance configuration are described. This indicates that, when the current performance classification is low performance and the prediction performance classification after 30 minutes is low performance, if the current configuration of the virtual tape device is the high performance configuration, the configuration is changed to the low performance configuration, if the current configuration is the intermediate performance configuration, the configuration is changed to the low performance configuration, and if the current configuration is the low performance configuration, the configuration is not changed.

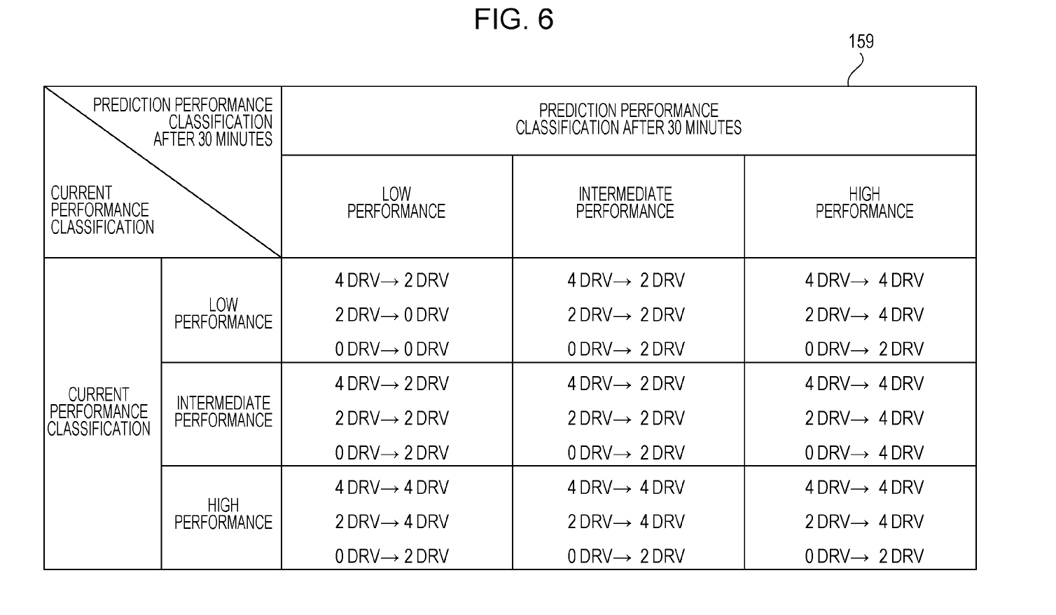

FIG. 6 is an example of the data transfer performance comparison table.

The data transfer performance comparison table 159 has a column item of prediction value after 30 minutes and a row item of current performance classification. Each of the prediction value after 30 minutes and the current performance classification has items of low performance, intermediate performance, and high performance.

In each field of the data transfer performance comparison table 159, a current configuration (the number of physical tape drives currently used by the LIB 191) and a configuration after change (the number of physical tape drives that will be used by the LIB 191 after the change) are described. In each field of the data transfer performance comparison table 159, the current configuration is described on the left side of the right arrow (->) and the configuration after change is described on the right side of the right arrow.

For example, in a field corresponding to a row in which the current performance classification is low performance and a column in which the prediction performance classification after 30 minutes is low performance, 4DRV->2DRV, 2DRV->ODRV, and ODRV->ODRV are described. This indicates that, when the current performance classification is low performance and the prediction performance classification after 30 minutes is low performance, if the number of physical tape drives currently used by the LIB 191 is 4, the number is changed to 2, if the number of physical tape drives currently used by the LIB 191 is 2, the number is changed to 0, and if the number of physical tape drives currently used by the LIB 191 is 0, the number is not changed.

Next, the configuration in high performance mode (high performance configuration), the configuration in intermediate performance mode (intermediate performance configuration), and the configuration in low performance mode (low performance configuration) of the virtual tape device 101 and the configuration in physical tape drive rest mode will be described.

FIG. 7 is a configuration diagram in the high performance mode of the virtual tape device according to the embodiment. In FIG. 7, the PCU 151 and the PDU 161 are omitted.

In the high performance configuration, a functional control of each function process of a data processing system is assigned to a dedicated processing unit respectively in order to operate at a maximum performance. Specifically, the IC 112 runs in the ICP 111, the VL 125 runs in the VLP 121, and the ID 137 runs in the IDP 131.

Storing/reading data of a logical volume transferred from the host 101 is shared and performed in parallel by the three processing units (ICP 111, VLP 121, and IDP 131), so that the processing speed is increased.

FIG. 8 is a configuration diagram in the intermediate performance mode of the virtual tape device according to the embodiment.

In FIG. 8, the PCU 151 and the PDU 161 are omitted.

In the intermediate performance configuration, a function of the VLP 121 and data being processed in the VLP 121 are moved to the ICP 111. The VLP 121 stops, the ICP 111 stores the LM information, and the control program 112 executes two function processes (VL 115 and IC 116), one of which is moved from the VLP 121. In the IDP 131, the ID 137 runs in the same manner as in the high performance mode. In this way, in the intermediate performance configuration, the operation is performed by reducing the power consumption of the virtual tape device 101 while minimizing the decrease in the data processing performance.

The intermediate performance configuration is not limited to the above example, and for example, a configuration is possible in which the ICP 111 is stopped and the VLP 121 executes the VL 125 and the IC 126 or the IDP 131 executes the IC 136 and the ID 137. Also, in the intermediate performance configuration, for example, a configuration is possible in which the IDP 131 is stopped and the ICP 111 executes the IC 116 and the ID 117 or the VLP 121 executes the VL 125 and the ID 127.

In short, in the intermediate performance configuration, one processing unit is stopped and a function process which performs the same process as that of the function process executed by the stopped processing unit is executed by one of the processing units other than the stopped processing unit.

FIG. 9 illustrates a configuration in the low performance mode of the virtual tape device according to the embodiment.

In FIG. 9, the PCU 151 and the PDU 161 are omitted.

In the low performance configuration, two processing units (ICP 111 and IDP 131) stop and all the function processes (VL 125, IC 126, and ID 127) run in one processing unit (VLP 121). Thereby, in the virtual tape device 101, it is possible to perform a power saving operation while maintaining the function of the virtual tape device 101.

At this time, if the performance of the back end side (the performance of the IDP) is the lowest, part of the physical tape drives is turned off to realize the maximum effect of power saving.

The low performance configuration is not limited to the above example, and for example, a configuration is possible in which the ICP 111 and the VLP 121 are stopped and the IDP 131 executes all the function processes (VL 135, IC 136, and the ID 137). Also, in the low performance configuration, for example, a configuration is possible in which the VLP 121 and the IDP 131 are stopped and the ICP 111 executes all the function processes (VL 115, IC 116, and the ID 117).

In short, in the low performance configuration, two processing units are stopped and function processes which perform the same processes as those of the function processes executed by the stopped processing units are executed by the processing unit other than the stopped processing units.

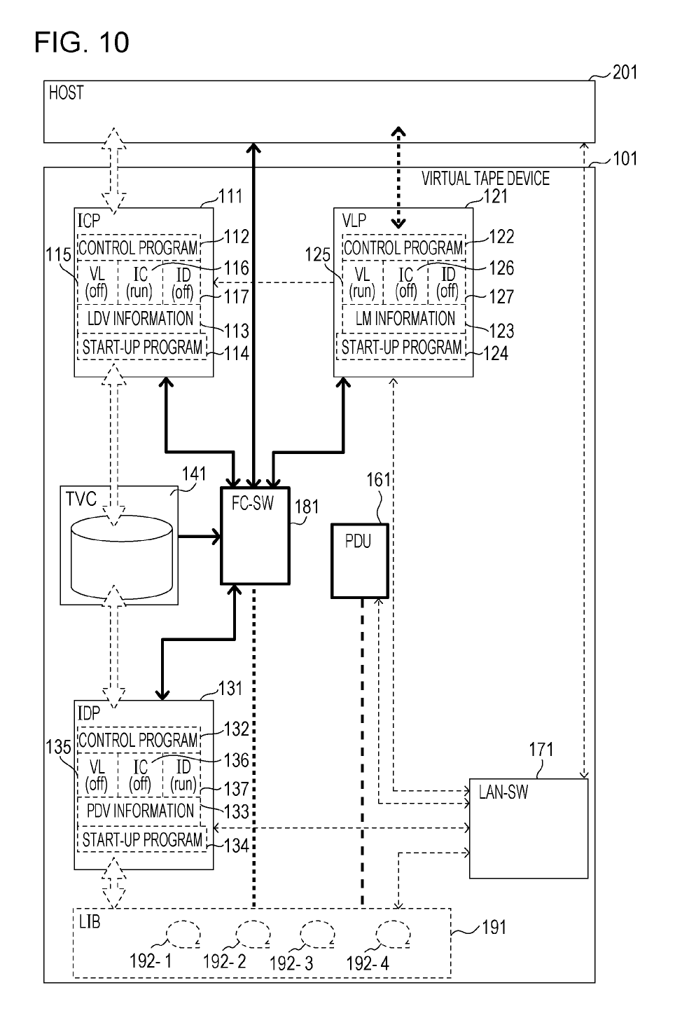

FIG. 10 is a configuration diagram in the physical tape drive rest mode of the virtual tape device according to the embodiment.

When the data transfer amount is the minimum, a load of the back end side (a load of the IDP 131 and a load of the physical tape drives 192) becomes minimum. Therefore, the smallest possible number of physical tape drives 192 are run and redundant physical tape drives 192 are turned off, so that a power saving operation is performed.

A tape job is scheduled and a predetermined volume is processed at a predetermined time in a predetermined sequence. In a processing unit to be monitored, a past “mount performance value” of a virtual tape is stored every specific period of time (for example, every 30 minutes), a period of time of the low mount performance is predicted from the stored operation state, and the PCU 151 changes a connection configuration of the processing unit by a monitoring process control function according to the prediction.

For example, if, in the virtual tape device, a backup job is performed from 20:00 to 24:00, no job is performed (there is no access to tape) from 24:00 to 8:00 in the next morning, and a batch job is performed from 8:00 to 20:00, the mount performance value (load) and the data transfer performance value (load) of the processing unit are the maximum in the period of time from 20:00 to 24:00 in which the backup job is performed and the mount performance value and the data transfer performance value of the processing unit are the minimum in a period of time from 24:00 to 8:00 in the next morning.

Therefore, the virtual tape device is operated in the high performance configuration illustrated in FIG. 7 from 20:00 to 24:00. From 8:00 to 20:00, as illustrated in FIG. 8, the configuration is switched to the intermediate performance configuration in which a function of the VLP 121 and data being processed in the VLP 121 are moved to the ICP 111 and the control program 112 of the ICP 111 executes two function processes including the moved function process, so that the virtual tape device 101 is operated while minimizing the decrease in the data processing performance.

From 24:00 to 8:00 in the next morning, there is no job or there is a minimum load, so that the configuration is changed to the low performance configuration in which a group of all the function processes is started and processed in one unit (VLP 121) as illustrated in FIG. 9. Thereby, the virtual tape device 101 is caused to have an operation continuing capability with a minimum configuration in which the power saving effect is the maximum.

On the other hand, a past “data transfer performance value” of the virtual tape device 101 is stored every specific period of time (for example, every 30 minutes), a period of time of the low data transfer speed is predicted from the stored operation state, and the PCU 151 changes a connection configuration of the physical tape drives/connection library on the back end side by the monitoring process control function according to the prediction.

For example, from 20:30 to 24:30, the physical tape drives 192 are operated in a 4-drive configuration, and from 8:30 to 20:30, the physical tape drives 192 are operated in a 2-drive configuration and a back end job is performed. From 24:30 to 8:30 in the next morning, there is no job or the amount of handled data is the minimum, so that if the number of the physical tape drives 192 in use is sequentially decreased every 30 minutes, such as from 4 drives to 2 drives to 0 drive, and the number of the physical tape drives 192 in use is restored from 0 drive to 2 drives at 8:30, the power saving effect is the maximum while maintaining the operation continuing capability.

In this way, in the virtual tape device 101, part of units (including the LIB 191) is stopped according to a load state and a stopped function is performed by another unit, so that the operation of the virtual tape device 101 can be continued regardless of the process performance and a power saving operation can be performed.

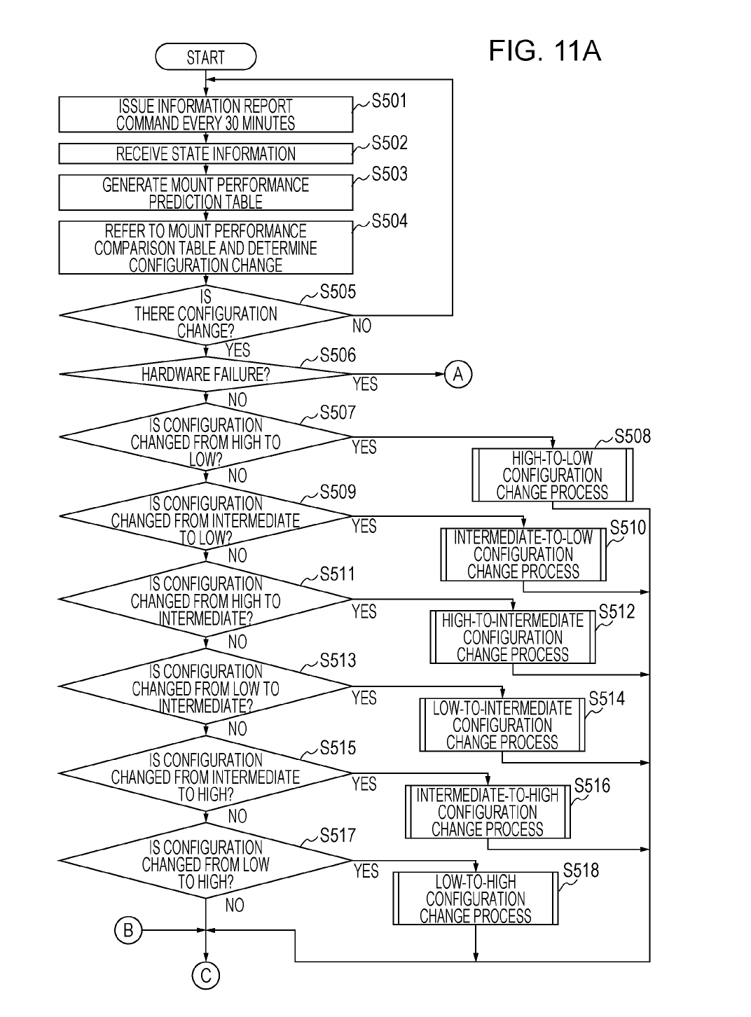

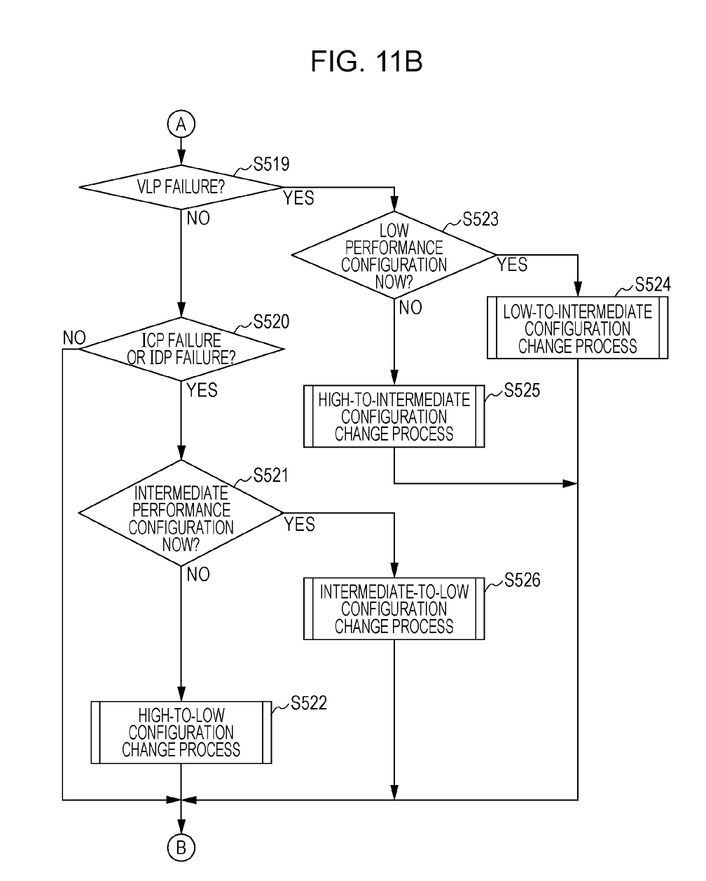

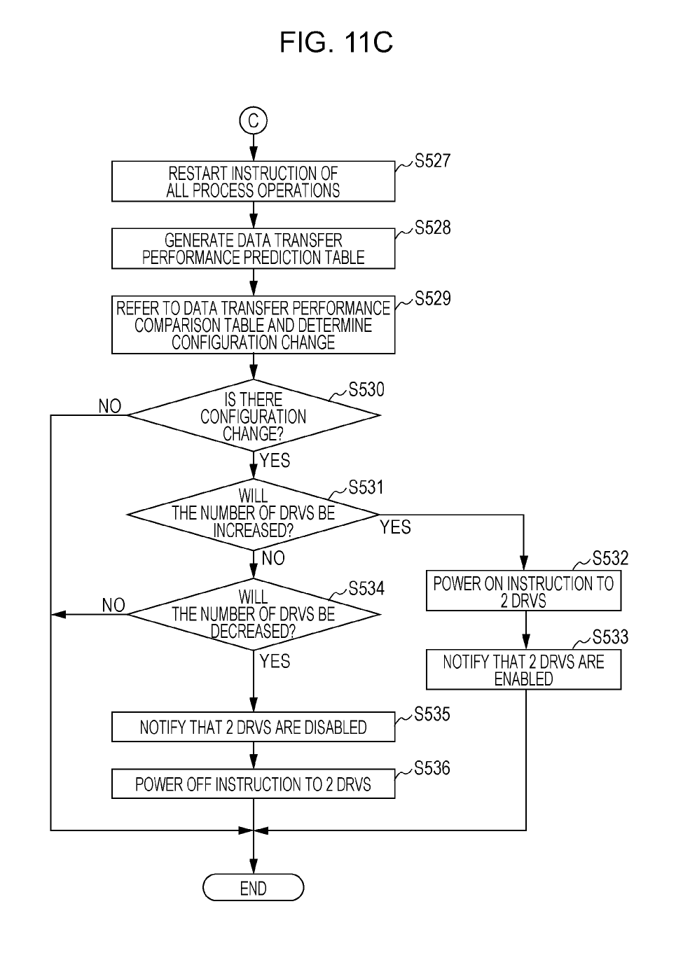

FIGS. 11A, 11B, and 11C are methods of a configuration change process according to the embodiment.

In step S501, the processing unit state monitoring unit 152 issues an information report command to the ICP 111, the VLP 121, and the IDP 131 through the LAN-SW 171. The PCU 151 issues the information report command every 30 minutes. In other words, the PCU 151 issues the information report command when 30 minutes have elapsed since the previous issuance of the information report command. The ICP 111, the VLP 121, and the IDP 131 which receive the information report command transmit the configuration information, the operation information, the mount performance value, the data transfer performance value, and the information of the presence or absence of hardware failure to the PCU 151. However, the mount performance value is transmitted from a processing unit in which the VL function process is running (VLP 121 in FIG. 1) and the data transfer performance value is transmitted from a processing unit in which the IC function process is running (ICP 111 in FIG. 1). Here, the configuration information, the operation information, the mount performance value, the data transfer performance value, and the information of the presence or absence of hardware failure are called state information.

In step S502, the processing unit state monitoring unit 152 receives the state information.

In step S503, the processing unit start/stop switching controller 153 calculates the average value and the performance classification corresponding to the current mount performance value on the basis of the received state information and generates the mount performance prediction table 156. In the embodiment, when the mount performance value is greater than or equal to 100 m/s, it is defined as high performance, when the mount performance value is greater than or equal to 1 m/s and smaller than 100 m/s, it is defined as intermediate performance, and when the mount performance value is smaller than 1 m/s, it is defined as low performance.

In step S504, the processing unit start/stop switching controller 153 refers to the mount performance comparison table 158 and determines whether or not to change the configuration of the virtual tape device 101, and when changing the configuration, determines to which configuration the configuration will be changed on the basis of the current configuration of the mount performance comparison table 158 and the mount performance prediction table 156.

For example, in the mount performance prediction table 156 in FIG. 3, the performance value at the time Jun. 27, 2012 19:30 is 10 m/s (intermediate performance) and the performance prediction value after 30 minutes is 148 m/s (high performance). When the current configuration is “intermediate performance configuration”, it is determined that a configuration change from the “intermediate performance configuration” to the “high performance configuration” is desirable from the mount performance comparison table 158 in FIG. 5. Even when the current performance value is 0 m/s (low performance), if the current configuration is the “intermediate performance configuration”, it is determined that a configuration change from the “intermediate performance configuration” to the “high performance configuration” is desirable from the mount performance comparison table 158. Similarly, when the mount performance value at the time Jun. 27, 2012 19:30 is 150 m/s (high performance), if the current configuration is the “intermediate performance configuration”, it is determined that a configuration change from the “intermediate performance configuration” to the “high performance configuration” is desirable from the mount performance comparison table 158.

In step S505, if there is a configuration change, the control proceeds to step S506, and if there is no configuration change, the control returns to step S501.

In step S506, the processing unit start/stop switching controller 153 refers to the mount performance prediction table 156 and determines whether or not there is a hardware failure. If there is a hardware failure, the control proceeds to step S519, and if there is no hardware failure, the control proceeds to step S507.

In step S507, if it is determined that the configuration is changed from the high performance configuration to the low performance configuration in step S504, the control proceeds to step S508, and if it is determined that the configuration is not changed from the high performance configuration to the low performance configuration, the control proceeds to step S509.

In step S508, the processing unit start/stop switching controller 153 performs a high-to-low configuration change process in which the configuration is changed from the high performance configuration to the low performance configuration. Details of the high-to-low configuration change process will be described later.

In step S509, if it is determined that the configuration is changed from the intermediate performance configuration to the low performance configuration in step S504, the control proceeds to step S510, and if it is determined that the configuration is not changed from the intermediate performance configuration to the low performance configuration, the control proceeds to step S511.

In step S510, the processing unit start/stop switching controller 153 performs an intermediate-to-low configuration change process in which the configuration is changed from the intermediate performance configuration to the low performance configuration. Details of the intermediate-to-low configuration change process will be described later.

In step S511, if it is determined that the configuration is changed from the high performance configuration to the intermediate performance configuration in step S504, the control proceeds to step S512, and if it is determined that the configuration is not changed from the high performance configuration to the intermediate performance configuration, the control proceeds to step S513.

In step S512, the processing unit start/stop switching controller 153 performs a high-to-intermediate configuration change process in which the configuration is changed from the high performance configuration to the intermediate performance configuration. Details of the high-to-intermediate configuration change process will be described later.

In step S513, if it is determined that the configuration is changed from the low performance configuration to the intermediate performance configuration in step S504, the control proceeds to step S514, and if it is determined that the configuration is not changed from the low performance configuration to the intermediate performance configuration, the control proceeds to step S515.

In step S514, the processing unit start/stop switching controller 153 performs a low-to-intermediate configuration change process in which the configuration is changed from the low performance configuration to the intermediated performance configuration. Details of the low-to-intermediate configuration change process will be described later.

In step S515, if it is determined that the configuration is changed from the intermediate performance configuration to the high performance configuration in step S504, the control proceeds to step S516, and if it is determined that the configuration is not changed from the intermediate performance configuration to the high performance configuration, the control proceeds to step S517.

In step S516, the processing unit start/stop switching controller 153 performs an intermediate-to-high configuration change process in which the configuration is changed from the intermediate performance configuration to the high performance configuration. Details of the intermediate-to-high configuration change process will be described later.

In step S517, if it is determined that the configuration is changed from the low performance configuration to the high performance configuration in step S504, the control proceeds to step S518, and if it is determined that the configuration is not changed from the low performance configuration to the high performance configuration, the control proceeds to step S527.

In step S518, the processing unit start/stop switching controller 153 performs a low-to-high configuration change process in which the configuration is changed from the low performance configuration to the high performance configuration. Details of the low-to-high configuration change process will be described later.

In step S519, if the VLP 121 fails, the control proceeds to step S523, and if the VLP 121 does not fail, the control proceeds to step S520.

In step S520, if the ICP 111 or the IDP 131 fails, the control proceeds to step S521, and if the ICP 111 and the IDP 131 do not fail, the control proceeds to step S527.

In step S521, if the current configuration is the intermediate performance configuration, the control proceeds to step S526, and if the current configuration is not the intermediate performance configuration, the control proceeds to step S522.

In step S522, the processing unit start/stop switching controller 153 performs the high-to-low configuration change process in which the configuration is changed from the high performance configuration to the low performance configuration. The details of the high-to-low configuration change process will be described later.

In step S523, if the current configuration is the low performance configuration, the control proceeds to step S524, and if the current configuration is not the low performance configuration, the control proceeds to step S525.

In step S524, the processing unit start/stop switching controller 153 performs the low-to-intermediate configuration change process in which the configuration is changed from the low performance configuration to the intermediated performance configuration. The details of the low-to-intermediate configuration change process will be described later.

In step S525, the processing unit start/stop switching controller 153 performs the high-to-intermediate configuration change process in which the configuration is changed from the high performance configuration to the intermediate performance configuration. The details of the high-to-intermediate configuration change process will be described later.

In step S526, the processing unit start/stop switching controller 153 performs the intermediate-to-low configuration change process in which the configuration is changed from the intermediate performance configuration to the low performance configuration. The details of the intermediate-to-low configuration change process will be described later.

In step S527, the processing unit start/stop switching controller 153 instructs the ICP 111, the VLP 121, and the IDP 131 to restart process operations.

In step S528, the processing unit start/stop switching controller 153 calculates the average value and the performance classification corresponding to the current data transfer performance value on the basis of the state information received in step S502 and generates the data transfer performance prediction table 157. In the embodiment, when the data transfer performance value is greater than or equal to 100 MB/s, it is defined as high performance (high load), when the data transfer performance value is greater than 0 MB/s and smaller than 100 MB/s, it is defined as intermediate performance (intermediate load), and when the mount performance value is 0 MB/s (that is, a state in which no data is transferred), it is defined as low performance (low load).

In step S529, the processing unit start/stop switching controller 153 refers to the data transfer performance comparison table 159 and determines whether or not to change the configuration (the number of the physical tape drives 192 to be used), and when changing the configuration, determines to which configuration the configuration will be changed on the basis of the number of currently used drives of the data transfer performance comparison table 159 and the data transfer performance prediction table 157.

For example, in the data transfer performance prediction table 157 in FIG. 4, the performance value at the time Jun. 27, 2012 19:30 is 13 MB/s (intermediate performance) and the performance prediction value after 30 minutes is 151 MB/s (high performance). If the number of currently used drives is 2 drives (2DRV), it is determined that a configuration change from 2 drives to 4 drives is desirable because “2DRV->4DRV” is described in the data transfer performance comparison table 159 in FIG. 6. Even when the current data transfer performance value is 0 MB/s (low performance) at this time, if the number of currently used drives is 2 drives (2DRV), it is determined that a configuration change from 2 drives to 4 drives is desirable because “2DRV->4DRV” is described in the data transfer performance comparison table 159 in FIG. 6.

In step S530, if there is a configuration change, the control proceeds to step S531, and if there is no configuration change, the process is completed.

In step S531, when increasing the number of drives in use, the control proceeds to step S532, and when not increasing the number of drives in use, the control proceeds to step S534.

In step S532, the processing unit start/stop switching controller 153 instructs the PDU 161 to start power supply to two drives. Thereafter, the PCU 151 instructs the LIB 191 to turn on two drives.

In step S533, after the two drives are started, the processing unit start/stop switching controller 153 notifies the ID function process and the VL function process running in the virtual tape device 101 that the two drives can be used. The VL function process takes out physical tapes from a storage shelf in the LIB 191 and mounts the physical tapes on drives and the ID function process starts write operations of the physical tape drives.

In step S534, when decreasing the number of drives in use, the control proceeds to step S535, and when not decreasing the number of drives in use, the process is completed.

In step S535, the processing unit start/stop switching controller 153 instructs the ID function process and the VL function process running in the virtual tape device 101 to stop write operations of two currently used physical tape drives. After completing the write operations, the VL function process performs an unmount process to take out the physical tapes from the physical tape drives and moves the physical tapes to the storage shelf in the LIB 191.

In step S536, after the physical tapes are saved in the storage shelf, the processing unit start/stop switching controller 153 of the PCU 151 instructs the LIB 191 to shut down the two drives. After the two drives are shut down, the PCU 151 causes the PDU 161 to stop the power supply to the two drives.

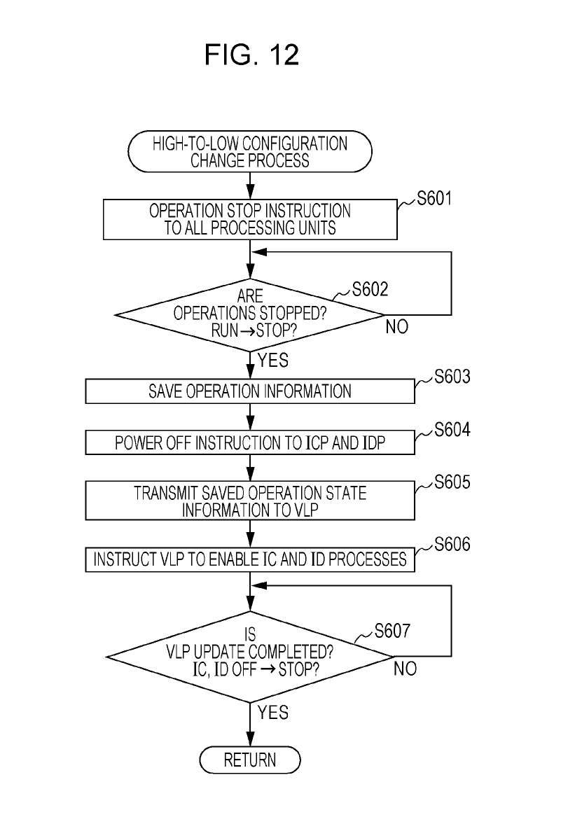

FIG. 12 is a detailed method of the high-to-low configuration change process.

In step S601, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S602, the control waits until all the processing units stop and when all the processing units stop, the control proceeds to step S603. When the VLs, the ICs, and the IDs of the ICP 111, the VLP 121, and the IDP 131 stop, it is determined that all the processing units stop.

In step S603, the processing unit start/stop switching controller 153 saves the operation information (LDV information 113, LM information 123, and PDV information 133) included in each processing unit in the PCU 151.

In step S604, the processing unit start/stop switching controller 153 instructs the ICP 111 and the IDP 131 to shut down and instructs the PDU 161 to stop power supply to the ICP 111 and IDP 131.

In step S605, the processing unit start/stop switching controller 153 transmits the operation information (LDV information 113, LM information 123, and PDV information 133) saved in the PCU 151 to the VLP 121. The VLP 121 stores the received operation information in the storage unit.

In step S606, the processing unit start/stop switching controller 153 instructs the VLP 121 to enable the IC 126 and the ID 127.

In step S607, the control waits until the IC 126 and the ID 127 of the VLP 121 start (are enabled) and are in a standby state (that is, the state changes from OFF state to STOP state), and the control ends the process when the IC 126 and the ID 127 of the VLP 121 are in the standby state (STOP state).

By the high-to-low configuration change process, the configuration of the virtual tape device 101 is changed from the high performance configuration illustrated in FIG. 7 to the low performance configuration illustrated in FIG. 9.

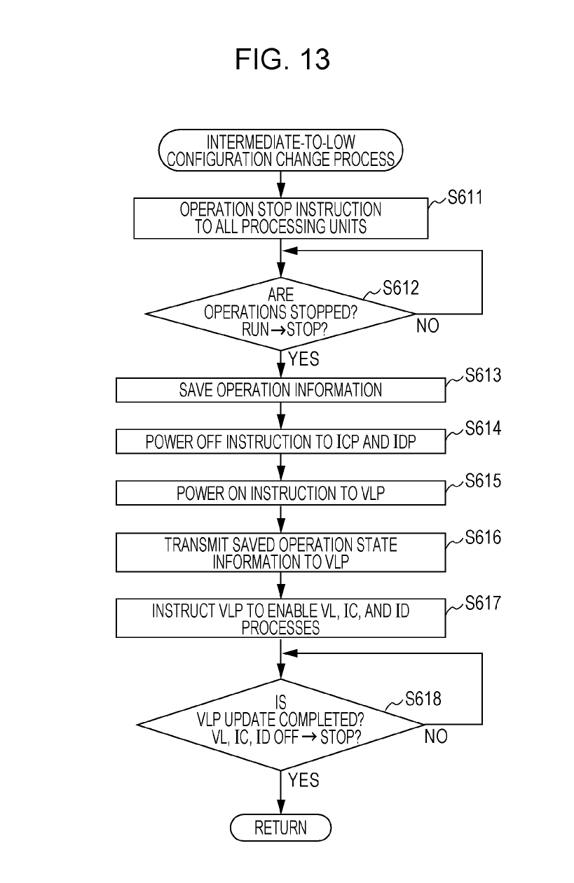

FIG. 13 is a detailed method of the intermediate-to-low configuration change process.

In step S611, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S612, the control waits until all the processing units stop and when all the processing units stop, the control proceeds to step S613. When the VLs, the ICs, and the IDs of the ICP 111, the VLP 121, and the IDP 131 stop, it is determined that all the processing units stop.

In step S613, the processing unit start/stop switching controller 153 saves the operation information (LDV information 113, LM information 123, and PDV information 133) included in each processing unit in the PCU 151.

In step S614, the processing unit start/stop switching controller 153 instructs the ICP 111 and the IDP 131 to shut down and instructs the PDU 161 to stop power supply to the ICP 111 and IDP 131.

In step S615, the processing unit start/stop switching controller 153 instructs the PDU 161 to supply power to the VLP 121 and instructs the VLP 121 to start. The start-up program 124 of the VLP 121 performs a start-up process.

In step S616, the processing unit start/stop switching controller 153 transmits the operation information (LDV information 113, LM information 123, and PDV information 133) saved in the PCU 151 to the VLP 121. The VLP 121 stores the received operation information in the storage unit.

In step S617, the processing unit start/stop switching controller 153 instructs the VLP 121 to enable the VL 125, the IC 126, and the ID 127.

In step S618, the control waits until the VL 125, the IC 126, and the ID 127 of the VLP 121 start (are enabled) and are in a standby state (that is, the state changes from OFF state to STOP state), and the control ends the process when the VL 125, the IC 126, and the ID 127 of the VLP 121 are in the standby state (STOP state).

By the intermediate-to-low configuration change process, the configuration of the virtual tape device 101 is changed from the intermediate performance configuration illustrated in FIG. 8 to the low performance configuration illustrated in FIG. 9.

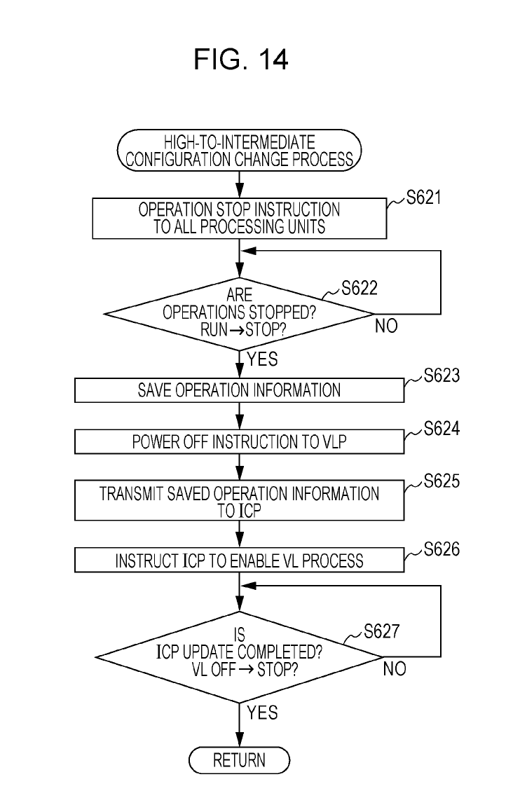

FIG. 14 is a detailed method of the high-to-intermediate configuration change process.

In step S621, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S622, the control waits until all the processing units stop and when all the processing units stop, the control proceeds to step S623. When the VLs, the ICs, and the IDs of the ICP 111, the VLP 121, and the IDP 131 stop, it is determined that all the processing units stop.

In step S623, the processing unit start/stop switching controller 153 saves the operation information (LDV information 113, LM information 123, and PDV information 133) included in each processing unit in the PCU 151.

In step S624, the processing unit start/stop switching controller 153 instructs the VLP 121 to shut down and instructs the PDU 161 to stop power supply to the VLP 121.

In step S625, the processing unit start/stop switching controller 153 transmits the operation information (LDV information 113 and LM information 123) saved in the PCU 151 to the ICP 111. The ICP 111 stores the received operation information in the storage unit.

In step S626, the processing unit start/stop switching controller 153 instructs the ICP 111 to enable the VL 115.

In step S627, the control waits until the VL 115 of the ICP 111 starts (is enabled) and is in a standby state (that is, the state changes from OFF state to STOP state), and the control ends the process when the VL 115 of the ICP 111 is in the standby state (STOP state).

By the high-to-intermediate configuration change process, the configuration of the virtual tape device 101 is changed from the high performance configuration illustrated in FIG. 7 to the intermediate performance configuration illustrated in FIG. 8.

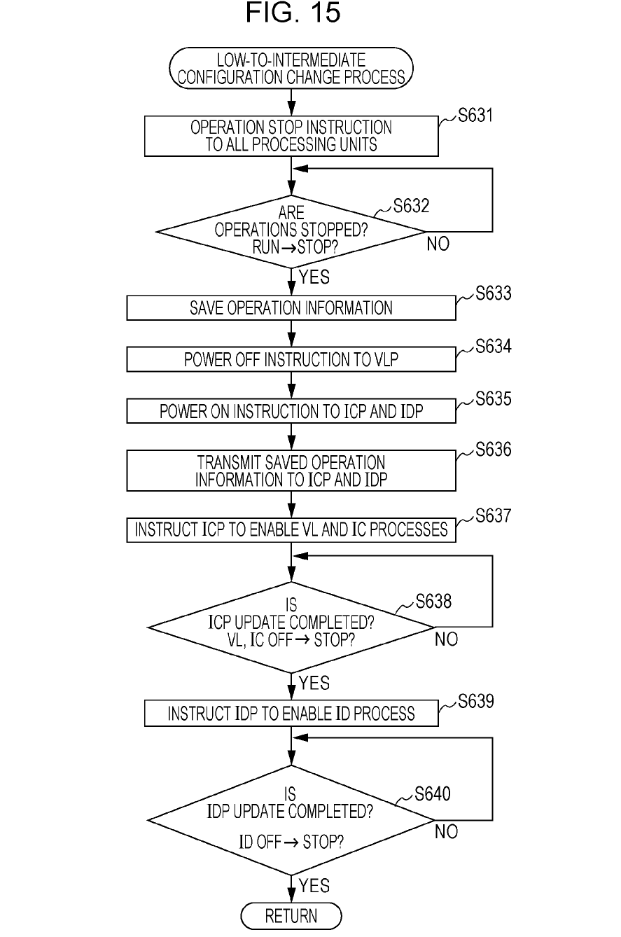

FIG. 15 is a detailed method of the low-to-intermediate configuration change process.

In step S631, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S632, the control waits until all the processing units stop and when all the processing units stop, the control proceeds to step S633. When the VLs, the ICs, and the IDs of the ICP 111, the VLP 121, and the IDP 131 stop, it is determined that all the processing units stop.

In step S633, the processing unit start/stop switching controller 153 saves the operation information (LDV information 113, LM information 123, and PDV information 133) included in each processing unit in the PCU 151.

In step S634, the processing unit start/stop switching controller 153 instructs the VLP 121 to shut down and instructs the PDU 161 to stop power supply to the VLP 121.

In step S635, the processing unit start/stop switching controller 153 instructs the PDU 161 to supply power to the ICP 111 and the IDP 131 and instructs the ICP 111 and the IDP 131 to start. The start-up programs 114 and 134 of the ICP 111 and the IDP 131 perform a start-up process.

In step S636, the processing unit start/stop switching controller 153 transmits the operation information (LDV information 113 and LM information 123) saved in the PCU 151 to the ICP 111 and transmits the operation information (PDV information 133) saved in the PCU 151 to the IDP 131. The ICP 111 and the IDP 131 respectively store the received operation information in the storage unit.

In step S637, the processing unit start/stop switching controller 153 instructs the ICP 111 to enable the VL 115 and the IC 116.

In step S638, the control waits until the VL 115 and the IC 116 of the ICP 111 start (are enabled) and are in a standby state (that is, the state changes from OFF state to STOP state), and the control proceeds to step S639 when the VL 115 and the IC 116 of the ICP 111 are in the standby state (STOP state).

In step S639, the processing unit start/stop switching controller 153 instructs the IDP 131 to enable the ID 137.

In step S640, the control waits until the ID 137 of the IDP 131 starts (is enabled) and is in a standby state (that is, the state changes from OFF state to STOP state), and the control ends the process when the ID 137 of the IDP 131 is in the standby state (STOP state).

By the low-to-intermediate configuration change process, the configuration of the virtual tape device 101 is changed from the low performance configuration illustrated in FIG. 9 to the intermediate performance configuration illustrated in FIG. 8.

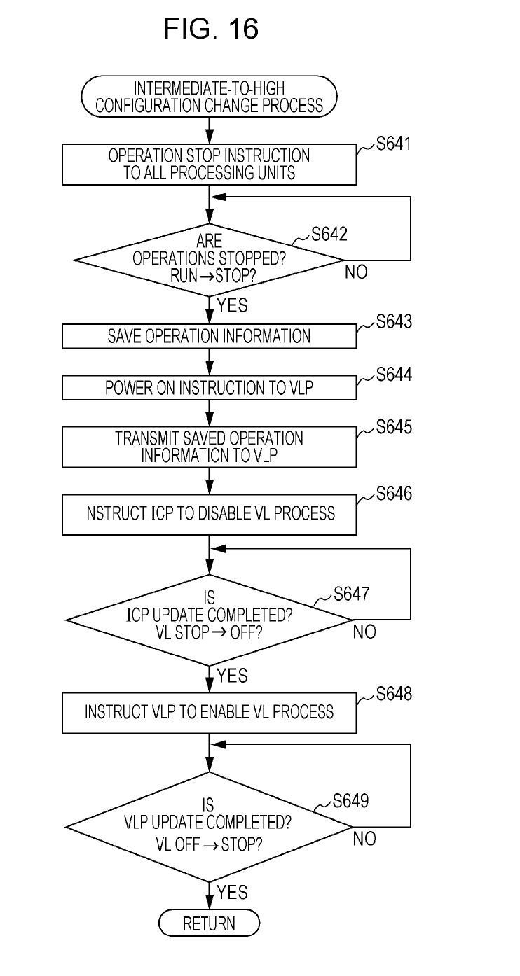

FIG. 16 is a detailed method of the intermediate-to-high configuration change process.

In step S641, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S642, the control waits until all the processing units stop and when all the processing units stop, the control proceeds to step S643. When the VLs, the ICs, and the IDs of the ICP 111, the VLP 121, and the IDP 131 stop, it is determined that all the processing units stop.

In step S643, the processing unit start/stop switching controller 153 saves the operation information (LDV information 113, LM information 123, and PDV information 133) included in each processing unit in the PCU 151.

In step S644, the processing unit start/stop switching controller 153 instructs the PDU 161 to supply power to VLP 121 and instructs the VLP 121 to start. The start-up program 124 of the VLP 121 performs a start-up process.

In step S645, the processing unit start/stop switching controller 153 transmits the operation information (LM information 123) saved in the PCU 151 to the VLP 121. The VLP 121 stores the received operation information in the storage unit.

In step S646, the processing unit start/stop switching controller 153 instructs the ICP 111 to disable the VL 115.

In step S647, the control waits until the VL 115 of the ICP 111 is disabled and when the VL 115 of the ICP 111 is disabled, the control proceeds to step S648.

In step S648, the processing unit start/stop switching controller 153 instructs the VLP 121 to enable the VL 125.

In step S649, the control waits until the VL 125 of the VLP 121 starts (is enabled) and is in a standby state (that is, the state changes from OFF state to STOP state) and the control ends the process when the VL 125 of the VLP 121 is in the standby state (STOP state).

By the intermediate-to-high configuration change process, the configuration of the virtual tape device 101 is changed from the intermediate performance configuration illustrated in FIG. 8 to the high performance configuration illustrated in FIG. 7.

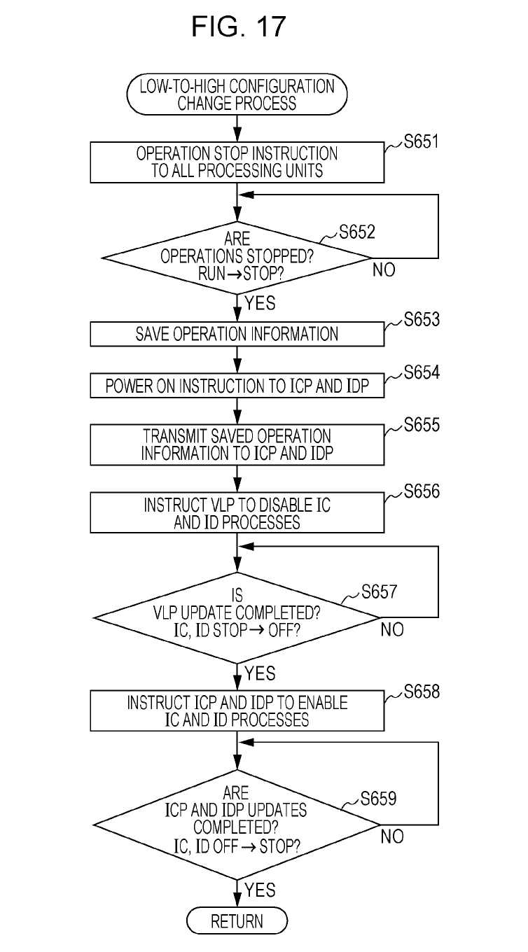

FIG. 17 is a detailed method of the low-to-high configuration change process.

In step S651, the processing unit start/stop switching controller 153 instructs all the processing units (ICP 111, VLP 121, and IDP 131) to stop. The ICP 111, the VLP 121, and the IDP 131 which receive the stop instruction stop the VLs 115, 125, and 135, the ICs 116, 126, and 136, and the IDs 117, 127, and 137 in these processing units.

In step S652, the control waits until all the processing units stop and when all the processing units stop, the control proceeds to step S653. When the VLs, the ICs, and the IDs of the ICP 111, the VLP 121, and the IDP 131 stop, it is determined that all the processing units stop.

In step S653, the processing unit start/stop switching controller 153 saves the operation information (LDV information 113, LM information 123, and PDV information 133) included in each processing unit in the PCU 151.

In step S654, the processing unit start/stop switching controller 153 instructs the PDU 161 to supply power to the ICP 111 and the IDP 131 and instructs the ICP 111 and the IDP 131 to start. The start-up programs 114 and 134 of the ICP 111 and the IDP 131 perform a start-up process.

In step S655, the processing unit start/stop switching controller 153 transmits the operation information (LDV information 113) saved in the PCU 151 to the ICP 111 and transmits the operation information (PDV information 133) saved in the PCU 151 to the IDP 131. The ICP 111 and the IDP 131 respectively store the received operation information in the storage unit.

In step S656, the processing unit start/stop switching controller 153 instructs the VLP 121 to disable the IC 126 and the ID 127.

In step S657, the control waits until the IC 126 and the ID 127 of the VLP 121 are disabled and when the IC 126 and the ID 127 of the VLP 121 are disabled, the control proceeds to step S658.

In step S658, the processing unit start/stop switching controller 153 instructs the ICP 111 to enable the IC 116 and instructs the IDP 131 to enable the ID 137.

In step S639, the control waits until the IC 115 of the ICP 111 and the ID 137 of the IDP 131 start (are enabled) and are in a standby state (that is, the state changes from OFF state to STOP state) and the control ends the process when the IC 115 of the ICP 111 and the ID 137 of the IDP 131 are in the standby state (STOP state).

By the low-to-high configuration change process, the configuration of the virtual tape device 101 is changed from the low performance configuration illustrated in FIG. 9 to the high performance configuration illustrated in FIG. 7.

According to the virtual tape device of the embodiment, the processing units are stopped according to the mount performance value (load), so that the virtual tape device can be operated by low power consumption.

According to the virtual tape device of the embodiment, the physical tape drives are stopped according to the data transfer performance value (load), so that the virtual tape device can be operated by low power consumption.

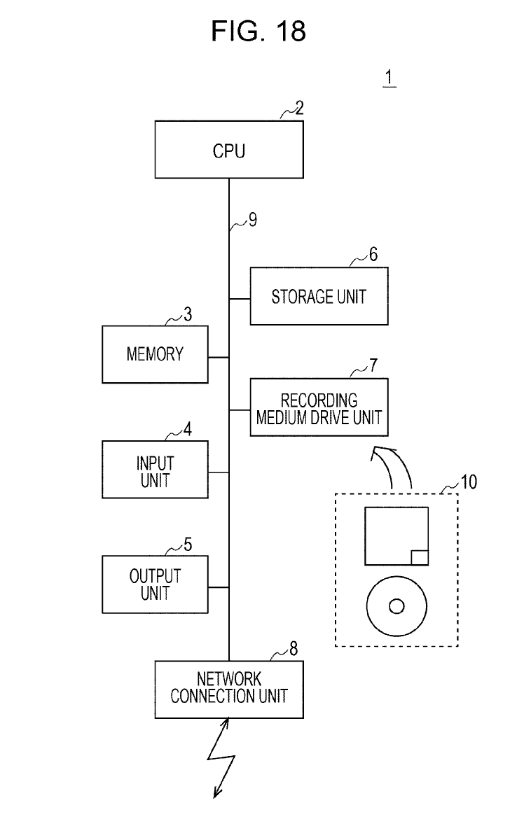

FIG. 18 is a configuration diagram of an information processing device (a computer).

The ICP 111, the VLP 121, the IDP 131, and PCU 151 are realized by, for example, the information processing device 1 as illustrated in FIG. 18.

The information processing device 1 includes a central processing unit (CPU) 2, a memory 3, an input unit 4, an output unit 5, a storage unit 6, a recording medium drive unit 7, and a network connection unit 8 and these units are connected to each other by a bus 9.

The CPU 2 is a central processing unit for controlling the entire information processing device 1. The CPU 2 corresponds to the processing unit state monitoring unit 152 and the processing unit start/stop switching controller 153.

The memory 3 is a memory such as a read only memory (ROM) and a random access memory (RAM) for temporarily storing a program or data stored in the storage unit 6 (or a portable recording medium 10) when executing a program. The CPU 2 performs the various processes described above by executing a program using the memory 3.

In this case, a program code itself read from the portable recording medium 10 or the like realizes the function of the embodiment.

The input unit 4 is, for example, a keyboard, a mouse, a touch panel, and the like.

The output unit 5 is, for example, a display, a printer, and the like.

The storage unit 6 is, for example, a magnetic disk device, an optical disk, a tape device, or the like. The information processing device 1 stores the program and data in the storage unit 6 and moves the program and data to the memory 3 to use the program and data if desired.

The recording medium drive unit 7 drives the portable recording medium 10 and accesses the recorded content in the portable recording medium 10. As the portable recording medium, any computer-readable recording medium, such as a memory card, a flexible disk, a compact disk read only memory (CD-ROM), an optical disk, or a magneto-optical disk, is used. A user stores the program and data in the portable recording medium 10 and moves the program and data to the memory 3 to use the program and data if desired.

The network connection unit 8 is connected to a communication network such as LAN and performs data conversion for the communication.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control device of a virtual storage system including a physical drive configured to store data of a logical volume in a storage medium and a plurality of processing devices configured to perform a mount process or an un-mount process for mounting the logical volume on a virtual drive that virtually stores data of the logical volume or for mounting a physical volume on the physical drive, the control device comprising:
a control unit that executes a process, wherein the process includes:
acquiring operation information indicating operation states of the plurality of processing devices and load information of the mount process from the processing devices;
determining a processing device to be started or to be stopped from the plurality of processing devices based on the acquired load information of the mount process, load prediction information of the mount process, and the number of the operating processing devices obtained from the acquired operation information, and
starting or stopping the determined the processing device.

2. The control device according to claim 1, wherein, when the control unit stops any of the plurality of processing devices, the control unit causes a processing device other than the processing device to be stopped to perform the process which is performed by the processing device to be stopped.

3. The control device according to claim 1, wherein the control unit acquires failure information indicating a presence or an absence of failure of each of the plurality of processing devices, stops a processing device with the failure, and causes a processing device other than the processing device with the failure to perform the process which is performed by the processing device with the failure.

4. The control device according to claims 1, wherein the control unit acquires data transfer load information indicating data throughput per a certain time period from any of the plurality of processing devices, determines a processing device to be started or to be stopped based on the acquired data transfer load information, prediction information of data transfer load after the certain time period, and the number of operating physical drives, and starts or stops the determined processing device.

5. A virtual storage system comprising:
a physical drive configured to store data of a logical volume in a storage medium;
a plurality of processing devices configured to perform a mount process or an un-mount process for mounting the logical volume on a virtual drive that virtually stores data of the logical volume or for mounting a physical volume on the physical drive; and
a control device including a control unit that executes a process, wherein the process includes:
acquiring operation information indicating operation states of the plurality of processing devices and load information of the mount process from the processing devices,
determining a processing device to be started or to be stopped from the plurality of processing devices based on the acquired load information of the mount process, load prediction information of the mount process, and the number of the operating processing devices obtained from the acquired operation information, and
starting or stopping the determined the processing device.

6. A method for executing by a control device of a virtual storage system that includes a physical drive configured to store data of a logical volume in a storage medium and a plurality of processing devices configured to perform a mount process or an un-mount process for mounting the logical volume on a virtual drive that virtually stores data of the logical volume or for mounting a physical volume on the physical drive, the method comprising:
acquiring operation information indicating operation states of the plurality of processing devices and load information of the mount process from the processing devices;
determining a processing device to be started or to be stopped from the plurality of processing devices based on the acquired load information of the mount process, load prediction information of the mount process, and the number of the operating processing devices obtained from the acquired operation information; and
starting or stopping the determined the processing device.
